(19) United States
(12) Patent Application Publication
(10) Pub. No.: US 2017/0348926 A1
(43) Pub. Date: Dec. 7, 2017

(54) REPAIR AND REINFORCEMENT METHOD FOR AN AIRCRAFT

(71) Applicant: Sikorsky Aircraft Corporation, Stratford, CT (US)

(72) Inventors: Wenping Zhao, Glastonbury, CT (US); Zaffir A. Chaudhry, South Glastonbury, CT (US); Mark R. Jaworowski, Glastonbury, CT (US)

(73) Assignee: Sikorsky Aircraft Corporation, Stratford, CT (US)

(21) Appl. No.: 15/518,325

(22) PCT Filed: Oct. 12, 2015
(86) PCT No.: PCT/US2015/055094

§ 371 Date: Apr. 11, 2017

Related U.S. Application Data
(60) Provisional application No. 62/063,206, filed on Oct. 13, 2014.

(51) Int. Cl. B29C 73/10; B29C 73/26; B29L 31/30

(52) U.S. Cl. CPC B29C 73/10; B29C 73/26; B29L 2031/3076; B29C 2073/262

(57) ABSTRACT

A repair and reinforcement method for an aircraft is provided. The method includes cleaning a corroded portion of a structure of the aircraft, applying an adhesive layer to the cleaned portion of the structure and forming a polymer matrix composite (PMC) patch for application to the adhesive.

### CROSS-REFERENCE TO RELATED APPLICATIONS

The present application is a 371 National Stage of International Patent Application No. PCT/US2015/055094, filed on Oct. 12, 2015, which claims priority to U.S. Provisional Application No. 62/063,206, filed on Oct. 13, 2014, the contents of which are incorporated herein by reference in their entirety.

### BACKGROUND OF THE INVENTION

The subject matter disclosed herein relates to repair methods for corroded structures and, more particularly, to lightweight repair and reinforcement methods for corroded structures with polymer matrix composites (PMC).

Naval aircraft structures are frequently required to operate in harsh environments and are often severely impacted by corrosion. Such corrosion, beyond a certain degree, tends to compromise the structural integrity of the attendant structures and needs to be addressed. A common response to corrosion effects (beyond certain limits) in the field as well as at depot stations is to replace the corroded metallic skins and other structural elements. Such operations are not trivial and are costly and time consuming.

### BRIEF DESCRIPTION OF THE INVENTION

According to one aspect of the invention, a repair and reinforcement method for an aircraft is provided. The method includes cleaning a corroded portion of a structure of the aircraft, applying an adhesive layer to the cleaned portion of the structure and forming a polymer matrix composite (PMC) patch for application to the adhesive.

In accordance with additional or alternative embodiments, the method further includes identifying the corroded portion of the structure.

In accordance with additional or alternative embodiments, the cleaning includes cleaning an area of the structure around the corroded portion.

In accordance with additional or alternative embodiments, the applying of the adhesive layer includes applying a primer.

In accordance with additional or alternative embodiments, the primer includes an epoxy resin or polymer based primer.

In accordance with additional or alternative embodiments, the primer includes a corrosion inhibitor.

In accordance with additional or alternative embodiments, the forming of the PMC patch includes forming the PMC patch using a flexible and conformable prepreg.

In accordance with additional or alternative embodiments, the forming of the PMC patch includes saturating fibers with a resin matrix and curing the resin in place.

In accordance with additional or alternative embodiments, the forming of the PMC patch includes conforming the PMC patch to irregular structures or surface features.

According to another aspect of the invention, a repair and reinforcement apparatus for an aircraft is provided. The apparatus includes a corroded portion of a structure of the aircraft, a polymer matrix composite (PMC) patch formed to conform to the portion of the structure once cleaned and adhesive disposed to adhere the PMC patch to the portion of the structure.

In accordance with additional or alternative embodiments, the PMC patch encompasses an area of the corroded portion of the structure and a surrounding area.

In accordance with additional or alternative embodiments, the adhesive includes a primer.

In accordance with additional or alternative embodiments, the primer includes at least one of an epoxy resin or polymer based primer and a corrosion inhibitor.

In accordance with additional or alternative embodiments, the PMC patch includes one of a flexible and conformable prepreg and fibers saturated with a curable resin matrix.

In accordance with additional or alternative embodiments, the corroded portion of the structure includes irregular surface features.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a flow diagram illustrating a repair and reinforcement method for an aircraft in accordance with embodiments

FIG. 2 is a side schematic view of a corroded portion of a structure of an aircraft;

FIG. 3 is a side schematic view of a cleaned portion of the structure of FIG. 2;

FIG. 4 is a side schematic view of an adhesive layer applied to the cleaned portion of the structure of FIG. 3; and

FIG. 5 is a side schematic view of a polymer matrix composite (PMC) patch applied to the adhesive layer of FIG. 4.

The detailed description explains embodiments of the invention, together with advantages and features, by way of example with reference to the drawings.

### DETAILED DESCRIPTION OF THE INVENTION

As will be described below, while common corrosion responses involve replacement of corroded parts, a new method of repair and reinforcement is provided. This new method includes the identification and cleaning of a corroded part and a reinforcement of the part with a lightweight, yet stiff, polymer matrix composite (PMC) patch. The PMC patch can be applied at a depot station or in the field and provides requisite structural stiffness to flat or complex geometries (i.e., where the corroded part is curved and/or riveted). The PMC patch also forms an environmental barrier thereby preventing further corrosion due to, e.g., sub-surface corrosion, which, if present, will be isolated from the environment. Although PMC has been recognized for light-weight properties as well as superior fatigue and corrosion resistance characteristics, PMC has not been previously utilized for repair and prevention of aircraft corrosion damage.

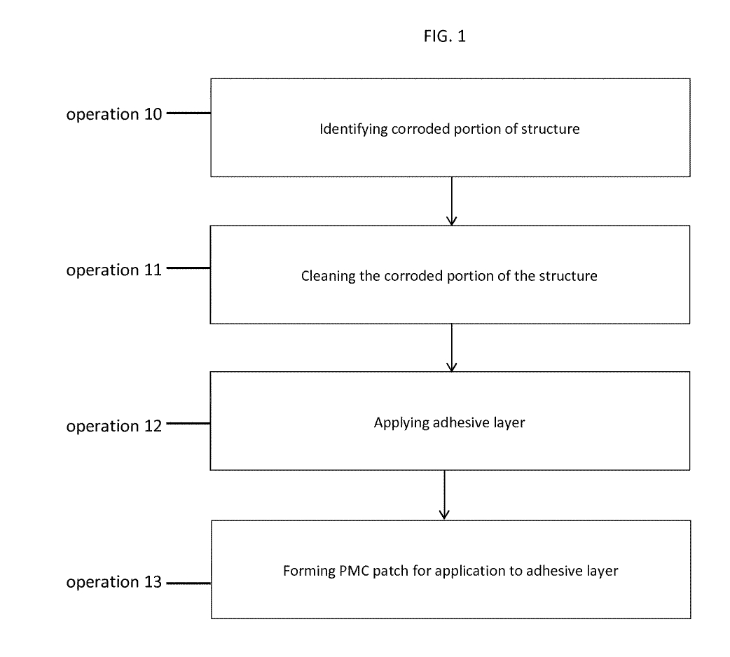

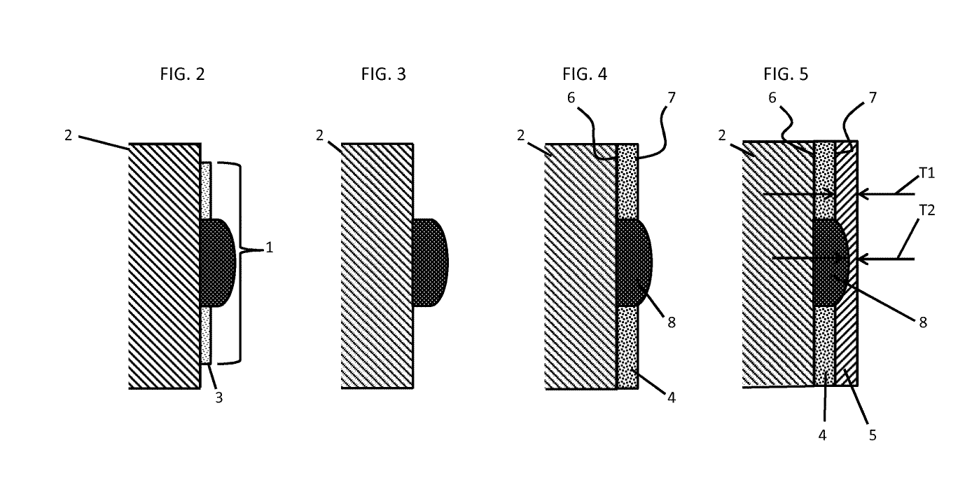

With reference to FIG. 1 and, with additional reference to FIGS. 2-5, a repair and reinforcement method for use with an aircraft, such as a naval aircraft, is provided. The aircraft generally has an outer metallic structure or skin that is formed into various aerodynamic features, including the fuselage, the engine casings, wings and the tail. In each case, the structure is frequently exposed to extreme environmental conditions and impact damage that can lead to corrosion of the metallic material of the structure. Over time, this corrosion may become increasingly severe and eventually exceed acceptable levels. At such times, the repair and reinforcement method described herein may be applied.

The method initially includes identifying a corroded portion 1 of the structure 2 of the aircraft (operation 10). This can be accomplished by standard optical inspection procedures or by meticulous examinations of each portion of the structure 2. Once identified, the corroded portion (or portions) of the structure is cleaned (operation 11). This cleaning can focus on removal of the surface of the corroded portion (i.e., the corroded layer 3) and, in some cases, the cleaning can address sub-surface corrosion as well. In any case, the corroded layer may be removed by any one or more of various cleaning processes including, but not limited to, applications of aqueous or solvent cleansers, sanding and abrasive hand finishing.

In some embodiments, the cleaning of operation 11 relates to only the corroded portion of the structure in order to limit possible unnecessary and time consuming work with respect to non-corroded portions. However, it will be understood that areas surrounding the corroded portion of the structure may be cleaned as well in accordance with process tolerances and in order to insure that all the corroded portion of the structure is cleaned. This additional cleaning is especially useful in cases where the corroded portion of the structure is irregularly shaped.

Once the cleaning of operation 11 is complete, an adhesive layer 4 is applied to the cleaned portion of the structure (operation 12) and a polymer matrix composite (PMC) patch 5 is formed for application to the adhesive (operation 13). The adhesive layer 4 may include a primer, such as an epoxy resin or polymer based primer, as well as a corrosion inhibitor. The corrosion inhibitor may be provided as part of the primer or as a stand-alone component of the adhesive layer 4. In some cases, the cleaning of operation 11 may be completed by application of an aqueous or solvent cleaner and the adhesive layer application of operation 12 may include application of a primer, which is provided as a wash priming surface preparation compound that combines polymer resin with surface modifications and corrosion inhibitors. Such a primer would be expected to form joints 6, 7 with both the base metal of the structure 2 and the PMC patch 5 and will provide for improved fatigue and environmental durability.

In accordance with embodiments, the forming of the PMC patch 5 of operation 13 may include forming the PMC patch 5 using a flexible and conformable prepreg whereas, in other alternative embodiments, the forming of the PMC patch 5 may include saturating a fibrous element in a resin matrix and curing the resin in place. In any case, the forming of the PMC patch 5 further includes conforming the PMC patch 5 to irregular surface features 8 of the structure 2 of the aircraft. Such irregular surface features 8 may include, for example, rivets and other similar components.

In those cases where the structure 2 of the aircraft includes the irregular surface features 8, the PMC patch 5 lies over the irregular surface features 8. Thus, while the PMC patch 5 may have a first thickness T1 at a point defined remotely from an irregular surface feature 8, the PMC patch 5 may have a second thickness T2 at a point corresponding to a location of an irregular surface feature 8. In cases where irregular surface feature 8 is raised or extends outwardly relative to the surrounding surface of structure 2, second thickness T2 would thus be thinner than the first thickness T1. Alternatively, the PMC patch 5 could bulge outwardly and have a thickness T1 at the location of the irregular surface feature 8. In cases where irregular surface feature 8 is recessed or extends inwardly relative to the surrounding surface of structure 2, second thickness T2 would be thicker than the first thickness T1. Alternatively, the PMC patch 5 could recede inwardly and have a thickness T1 at the location of the irregular surface feature 8.

Although not illustrated in FIGS. 2-5, it will be understood that the structure 2 of the aircraft may be substantially flat or curved. In either case, the PMC patch 5 will be formed to conform to the shape of the structure 2. Thus, if the structure 2 is flat, the PMC patch 5 will be similarly flat and, if the structure 2 is curved, the PMC patch 5 will be similarly curved. For the case of the PMC patch 5 using a flexible and conformable prepreg, the shaping of the PMC patch 5 can be accomplished at the repair site or at least partially at the patch formation site (i.e., with a molding shaped to conform to the shape of the structure 2). Alternatively, for the case of the PMC patch 5 being a resin-saturated fibrous element, the fibrous element may be laid against the structure 2 so that the fibrous element conforms to the shape of the structure. Then, once resin infiltration is completed and the resin is cured, the resulting PMC patch 5 should remain shaped like the structure 2.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A repair and reinforcement method for an aircraft, the method comprising:
cleaning a corroded portion of a structure of the aircraft;
applying an adhesive layer to the cleaned portion of the structure; and
forming a polymer matrix composite (PMC) patch for application to the adhesive.

2. The method according to claim 1, further comprising identifying the corroded portion of the structure.

3. The method according to claim 1, wherein the cleaning comprises cleaning an area of the structure around the corroded portion.

4. The method according to claim 1, wherein the applying of the adhesive layer comprises applying a primer.

5. The method according to claim 4, wherein the primer comprises an epoxy resin or polymer based primer.

6. The method according to claim 4, wherein the primer includes a corrosion inhibitor.

7. The method according to claim 1, wherein the forming of the PMC patch comprises forming the PMC patch using a flexible and conformable prepreg.

8. The method according to claim 1, wherein the forming of the PMC patch comprises:
saturating fibers in a resin matrix; and
curing the resin in place.

9. The method according to claim 1, wherein the forming of the PMC patch comprises conforming the PMC patch to irregular surface features.

10. A repair and reinforcement apparatus for an aircraft, the apparatus comprising:
a corroded portion of a structure of the aircraft;
a polymer matrix composite (PMC) patch formed to conform to the portion of the structure once cleaned; and
adhesive disposed to adhere the PMC patch to the portion of the structure.

11. The apparatus according to claim 10, wherein the PMC patch encompasses an area of the corroded portion of the structure and a surrounding area.

12. The apparatus according to claim 10, wherein the adhesive comprises a primer.

13. The apparatus according to claim 12, wherein the primer comprises at least one of an epoxy resin, a polymer based primer and a corrosion inhibitor.

14. The apparatus according to claim 10, wherein the PMC patch uses one of a flexible and conformable prepreg and fibers saturated in a curable resin matrix.

15. The apparatus according to claim 10, wherein the corroded portion of the structure comprises irregular surface features.
